(19) United States
(12) Patent Application Publication
(10) Pub. No.: US 2010/0102604 A1
(43) Pub. Date: Apr. 29, 2010

(54) Device for minimizing neck and head injury

(75) Inventors: Stephen B. Barnes, Lexington, KY (US); David M. Wood, Greenwood, IN (US); Wilbur Bewley, Nicholasville, KY (US); Rocky Zornes, Versailles, KY (US); Ivan M. George, Lexington, KY (US)

Correspondence Address: Michael Coblenz, Suite 325, 836 Euclid Avenue, Lexington, KY, 40502, US

(73) Assignee: BWI LLC, Greenwood, IN (US)

(21) Appl. No.: 12/587,739

(22) Filed: Oct. 13, 2009

Related U.S. Application Data
(63) Continuation-in-part of application No. 12/288,858, filed on Oct. 24, 2008, now abandoned.

(51) Int. Cl. B60R 21/02; B60N 2/48; B60N 2/26; B60N 2/28

(52) U.S. Cl. 297/250.1; 297/410

(57) ABSTRACT

An encircling head restraint rigidly though movably attached to a seat within a vehicle, such that in the event of a crash or other sudden movement, the head of the occupant of the seat is protected, and excess movement of the head and neck is prevented. The encircling head restraint sits around the head, but does not touch the head so that the occupant can move the head within the encircling head restraint. The encircling head restraint prevents excess movement of the head in all directions. In a preferred embodiment the encircling head restraint is movably mounted to a child's car seat such that it can be adjusted up or down to fit properly on the head of the child. The encircling head restraint is adjustable to accommodate different sized heads. There is a hinge mechanism that allows the encircling head restraint to be easily moved out of the way to allow easy access to the seat by the occupant.

### CROSS REFERENCE TO RELATED APPLICATIONS

This application is a continuation-in-part, and claims priority to U.S. Non-Provisional patent application Ser. No. 12/288,858 filed on Oct. 24, 2008.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The present invention relates to a device for protecting the neck and head during an accident such as an automobile accident. More particularly the present invention related to a head support device that is attached to a seat in a moving vehicle. More particularly still, the present invention relates to an encircling head restrain that is movably and adjustably attached to the seat of a vehicle, or a seat secured in a vehicle such as a conventional child's protective car seat or booster seat, wherein the encircling head restraint prevents excessive head movement in any direction in the event of rapid or unusual movement of the seat such as occurs during an accident.

### BACKGROUND OF THE INVENTION

According to the National Highway Traffic Safety Administration, in 2005 nearly 1500 (1,451) children younger than fourteen died in car crashes, and approximately 203,000 were injured. On average there are four deaths and 556 injuries of children in cars every day, or approximately an injury every three minutes. (NHTSA 2006b) According to crash investigators, modern child protective car seats do not adequately protect the neck, the face, the brain (within the skull), and in infants, the soft crown on top of the head. Car seats are a valuable safety device and provide a great deal of useful protection, and protect children in many types of impact. For example a rear facing child seat will protect a child in a front impact because the child's head and body will be forced back against the car seat. A child in a rear-facing seat, however, will not be fully protected in a rear impact crash because the inertia will force the child to move forward in the seat, toward the back of the car and away from the protection of the car seat back. This will force the child's head forward with the potential to cause rapid or excessive movement of the head, which can cause “whiplash” or damage to the neck. Accidents at traffic lights and stop signs where the trailing vehicle hits the vehicle in front are exceedingly common. In many of these accidents, even at relatively low speeds, a child in a rear facing car seat can experience severe head movement. Similarly a child seat does not fully protect the child's head and neck in side impact crashes or rollover accidents. Infants and very small children (and some older people with physical disabilities) do not have the neck strength to fully support the weight of their head, and this makes their necks significantly more vulnerable in a car crash.

Automobile accidents or other similar jarring or sudden movements, can cause a wide variety of injuries to the head, neck, and brain. This is because of the force on the human body, and due to the fact that in many cases the head will move in unnatural ways in relation to the chest and shoulders. Whiplash is a good example of this extreme and unusual movement. Whiplash occurs when the body moves forward suddenly, which is why it often occurs in an accident where the vehicle is struck from behind. In this situation the body moves forward rapidly, but the head doesn't move forward at the same rate. This causes the head to move back, sometimes violently. When the head moves the body often attempts to compensate, by reflexively tightening muscles. Because of the restrains in a car, at some point the body stops the forward movement, and then the head snaps or whips forward. This can cause damage to the spine and skeletal structure of the neck, as well as to the muscles of the neck and related chest and shoulder muscles. Finally, the head will have moved as far forward as the spine will allow, and jerk to a stop. In some cases the brain inside the head will be slammed against the inside of the skull, when the head moves back, then when the head whips forward, and finally when the head stops moving. Whiplash is difficult to treat because it is not a single injury, but can be an injury to the skeleton and muscles throughout the upper body.

Roll-over accidents can be potentially very harmful to a child restrained in a car seat. In general the child in the car seat will be below the back of the seat of the vehicle itself, and so will be protected by the seat should the roof of the car be crushed down into the passenger compartment. But during the roll-over the child will be moving in many directions within the car seat. Roll-overs are a particular problem in vehicles with high centers of gravity, such as SUV's or Minivans, both of which are very popular among parents with children. Injuries caused in such situations are known as diffuse axonal injuries, because they can result from the movement of the head in relation to the body in many different axis of orientation. A child's head would need to be protected in a full 360° to prevent these types of injuries. All of these impact injuries can cause extensive tearing of neck muscle and tissue but can also damage nerve tissue throughout the brain. These brain injuries can also cause the release of various brain chemicals, which can result in additional brain injury. These brain injuries can cause brain damage, coma and even death. (Brain Injury Source Vol 4). The brain is injured because it moves within the skull, or cranial cavity. Rapid movements, particularly rapid acceleration and deceleration, can cause the brain to move violently within the skull and slam into the skull when the head stops moving. This is not uncommon in whiplash injuries where the head stops moving but the brain impact the inside of the skull. This can cause a variety of traumatic closed head injuries and shearing injuries. The symptoms of these injuries can range from mild headaches to severe brain damage.

There are a number of new automobile safety features that have made driving increasingly safe. They do so by greatly reducing the potential of and extent of injury in a crash. Some of the new safety features include a variety of air bags, including side impact air bags, knee air bags, and speed sensitive front airbags. Other safety features include intelligent head rests that automatically move forward to prevent whiplash (or violent snapping of head and neck in an impact), seat belts that pretension based on braking intensity, and front seats that automatically inflate front and side lumbar support in an accident. All of these features greatly improve passenger safety. Unfortunately children are placed in car seats—including child protective car seats for infants and small children and booster seats for larger children—that lack these features. Protective car seats are now mandatory in every state, and these car seats have saved countless lives, but there are still a number of safety features that car seats lack. One of the main problems is that car seats are often incorrectly installed. To overcome this problem, starting in 2003 most cars incorporated a standard child seat mount known as the LATCH® mount. The LATCH® mount includes a lower front latch mechanism and two upper latch attachments to securely attach the child's car seat in a vehicle.

In many situations car seats give parents the false impression that they have done everything possible to fully protect their children. While car seats are an extremely important safety advance, they are not fully protective. This can be seen by the numbers of injuries sustained by children riding in car seats. The vast majority of these injuries are caused by violent head movement during a car crash. This is particularly true in the case of infants and small children who have not yet developed neck muscles sufficiently strong to hold up their heads. Safety standards generally require that infants and very small children ride in rear facing car seats. As mentioned above, this position helps the child in a forward moving crash because the inertia of the crash will force the child's head toward the front of the car, and this is protected by the cushioning of the car seat. The rear facing car seat, however, is not helpful in a rear-end collision. Safety studies indicate that one of the most common minor automobile accidents is a relatively low speed crash while stopped at a stop light or red light. In these relatively minor accidents a trailing car will either fail to stop in time, or will start too early, and will bump into the forward car. If there is a child riding in a rear facing car seat in the forward car, there is the potential that their head will whip backward, causing neck injury.

There have been a handful of prior patents that have attempted to reduce the potential for injury among children riding in car seats. For example, U.S. Pat. No. 4,607,885 to del Fierro discloses a rigid U-shaped restraining member that sits around a child's head and attaches to a standard car seat by means of a strap. The strap can be connected by Velcro or snaps or buckle. This configuration appears to be derived from a head strap designed to hold a persons head against a seat, as seen in U.S. Pat. No. 4,339,151 to Riggs. The problem with a device like the Riggs patent is that it holds a person's head directly to the seat, thus preventing movement of the head. This may be desirable for sleeping, but in most situations it is highly uncomfortable. This device also holds the head in a slightly unnatural position. Most people lean their head slightly forward when sitting or standing. In this position the spine is not straight and the back is not flat, there is a slight forward bend of the neck. Forcing the head back is unnatural and slightly uncomfortable. Strapping the head in this position for extended lengths of time will cause neck fatigue and possibly even injury to the neck. The del Fierro patent has the same drawback as the Riggs strap device because it will force the head in an unnatural position. There are other drawbacks to the del Fierro invention. The most important is that the strap is essentially slipped over the back of the car seat and could be removed by the child in the seat by either un-strapping, or pushing up on the restraining member. The second problem is that the adult who is positioning the child in the seat has to strap the U-shaped restraint around the child's head while holding the child still. As anyone with a child can attest, this is not always an easy task. The final problem is that this device will not work for a larger child, one whose head extends above the back of the car seat.

A second child restrain device is U.S. Pat. No. 5,765,893 to Ziegler. The Ziegler device is a soft padded yoke that attaches to the standard shoulder harness and lap belt of a child's safety seat, and hold the child's head in place. The device is essentially a pillow with a hole in it, which holds the child down under the shoulder harness and lap belt, but has a hole for the child's face. This device is primarily designed for infants and very small children. While this device certainly achieves the result of securely restraining a child, it is highly improbably that an older child would accept the level of restrain involved in this device.

There have been a number of somewhat similar child seat devices developed primarily for use on the back of a bicycle. For example, U.S. Pat. No. 4,440,331 to Schimmels discloses a child seat with a releasably mounted protective hood. The hood is primarily designed to protect the child's head from external impact, such as in a fall from a bicycle. It is not designed to be snuggly fit over the child's head so as to prevent excessive movement of the head in a high speed crash. Another drawback of the Schimmels “hood” is that it is directly attached to the seat, and is therefore unusable when the child grows and the child's head extends above the top of the seat. The hood is connected, and removable, through flanges and connectors, and so while it is removable, it is not adjustable.

U.S. Pat. No. 5,542,587 to Broz et al, is drawn specifically to an infant carrier for use on a bicycle. The Broz carrier is designed for an infant or small child under about two years of age. The carrier includes a padded helmet. The helmet is attached to the child's head and then strapped to the seat. The child rides in a semi-prone position, and one purpose of the incorporated helmet it to keep the child from sitting up. The helmet is designed to protect the child from external impact in the event of a fall or crash of the bicycle, as well as to keep the child's head in proper alignment and protect the child's neck during a crash. There are a number of drawbacks to this invention. First, it will only work with small children. It is not conceivable that an older child would allow his or her head to be strapped to the carrier. An older child would most likely unstrap the helmet from the carrier, or take the helmet off. A second problem is that the device won't work once the child is large enough so that the head is near or above the top of the carrier. A final and perhaps most severe problem is that if the strap becomes detached from the car seat the child now has a heavy helmet on its head, and if there is a crash the neck would have to support the movement of the head with the additional weight of the helmet, which would actually exacerbate the potential harm to the neck. These bicycle helmets are designed to protect the head in relatively low speed fall or crash. This applies to Schimmels as well, even though it shows use in a car, because Schimmels' notes that it is designed primarily to protect the head from external damage. Broz notes that one feature is neck protection, but the helmet in Broz is made of a light-weight material that could break in a higher speed crash.

Neck injuries are a serious concern in all automobile accidents, but are of particular concern among race car drivers, who drive at high speeds and always face the possibility of a high speed car crash. In recent years, four highly notable drivers—Adam Petty, Kenny Irwin, Tony Roper and Dale Earnhardt Sr.—were killed in high speed crashes. Autopsies revealed that all died from neck trauma and/or basilar skull fractures. A number of inventions have been developed to prevent this type of injury, none more successful than U.S. Pat. No. 6,009,566 to Hubbard, which is know as the HANS Device®. (The title of the patent, “Head and Neck Support for Racing” provides the acronym HANS.) The HANS Device® is drawn to a brace that curves behind the neck and sits over the shoulders of a race car driver which prevents extreme and violent movement of the driver's helmet in a crash. The device also includes a strap that attaches to the helmet and holds the helmet close to the brace. The HANS Device® has proven remarkably successful, and drivers have walked away from many high speed crashes without serious head or neck injury. In April 2009, driver Carl Edwards was involved in a high speed crash at the Talladega Motor Speedway. Edward's car was traveling at over 200 miles per hour when it was bumped from behind by a car driven by Brad Keselowski, which caused Edwards's car to spin. Due to the high speed, Edward's car became airborne and crashed into the guard rail and fence separating the track from the spectators. Edward's car was ripped to pieces on the fence, but Edwards was able to crawl out of what remained of the driver's protective cage, and actually crossed the finish line of the race on foot. This is a testament to the protective ability of race car safety features, including the new HANS Device®. As a result, almost all race leagues have made use of the HANS Device® mandatory for drivers.

The protective yoke of the HANS Device® relies to a great degree upon the body strength of the race car driver. The yoke essentially keeps the head from moving in relation to the driver's body. While this is highly effective for physically fit adult race car drivers, it is not appropriate for small children, or infirm adults with physical disabilities. It is notable that a child's car seat has an integrated shoulder harness and lap belt system similar to the shoulder harness and lap belts worn by race car drivers. There is a need, therefore, for a device that similarly protects children or infirm adults riding in car seats from similar neck and head injury.

Head and neck injuries can also be sustained in other situations where the body is subject to unusual movement or rapid changes in direction. In these situations it is not unusual for the head to move separate from the body and thus potentially causing neck injury. A familiar example of a situation where the body is moving rapidly and can be subject to unusual forces that might cause the head to move are amusement park rides like roller coasters. There are many amusement rides that involved rapid motion of the body, such as the increasingly popular dropping movement rides, like Universal Studio's Tower of Terror, where the rider is given the impression that the elevator that they are riding in has come free and is dropping. All of these rides are specifically designed and engineered to give the rider the feeling of danger, but in a highly controlled and relatively safe environment. These rides are designed for safety and must be approved by safety officials before use and are subject to frequent inspections to ensure the safety of passengers. Despite all the safeguards, accidents and injuries do occur. And because the body is subject to movement accompanied by changes in direction, it is not uncommon for the neck or head to be injured. It is possible, therefore, for this device to be used as an additional safety feature in those settings.

There is a need, therefore, for a device that can prevent or significantly reduce the head movement of an occupant of a vehicle. There is also a need for a device that can protect the head in all directions in the event of an accident in a moving vehicle. There is also a need for a device that can absorb the energy of a sudden stop of the head to minimize internal head and brain injuries.

### SUMMARY OF THE INVENTION

In the broadest embodiment the invention is an adjustable head restrain that is connected to a seat of a vehicle, wherein the head restraint encircles the entire head to prevent rapid or jarring head movement during a sudden or rapid change of speed or orientation of the seat. The most common situation would involve a car crash. The encircling head restrain is attached to the seat such that it is easily adjustable to the proper location on the head. The device is defined herein as a support halo because it encircles the top of the head, much like a halo depicted in a Medieval or Renaissance church painting (see for example the “Lamentation of Christ” in the Scrovegni Chapel in Padua, Italy by Giotto di Bondone (circa 1305)), but like the modern version worn by countless children in church plays, this halo is held in position by a post or a series of posts. It is a support halo because it is designed to support the head and thereby protect the neck in the event of the kind of jarring movement of the body in the seat that would normally cause the head to move violently.

Though adjustable, the support halo is securely attached to the seat of a vehicle. The occupant of the seat, who will be strapped in to the seat by means of a conventional seat belt, or seat belt, shoulder strap, or shoulder harnesses, is relatively securely restrained in the seat in the event of a crash or rapid change of the inertial vector of the car and the seat within. While the arms and legs are also unrestrained, and will flail in a wreck, the head is a vital organ and much more in need of protection. Arms and legs might be strained and even broken in a high speed wreck, but those injuries, while severe, are generally not life-threatening. Injury to the head, neck or brain has the potential to be sever, and in some situations even life threatening. The head is not adequately secured in most vehicle seats. The seat can be a child's protective car seat, a child's booster seat, a car seat designed for special needs children or adults, and even a standard car seat. The support halo is securely and adjustably attached to the seat by means of a mechanism that will allow it to be moved up and down so that it can be properly positioned on the occupants head. The proper position is just above the ears, at about the same position that a hat is worn. If the seat moves rapidly the occupants head is held relatively securely in place so that the head does not move rapidly, thereby preventing or limiting strain or injury to the neck. While most support halos are generally circular, the support halo is not a perfect circle, although in one embodiment it could be. In most embodiments the support halo is four sided and essentially rectangular. Some of the sides may be curved to match, to some degree, the general curvature of the human head.

The main purpose of the support halo is to ensure that the body and the head retain approximately the same orientation during an accident and to prevent the head from moving excessively in relation to the upper torso of the body. In the most preferred embodiment, the support halo is integrated with a child's protective car seat to provide additional head and neck protection for infants and small children who are most vulnerable to head and neck injury because their necks generally lack strength. The support halo can also be used with child booster seats as well as in a standard automobile seat. The device can also be easily adapted for use in other configurations, such as for amusement park rides where the seat (generally located within such a ride as a roller-coaster) moved rapidly and in a jarring motion.

The support halo is an encircling head restraint. It is constructed of rigid or semi-rigid material and padded, and sits “on” the head at about the same level as a hat, or just above the ears and eyebrows. It is slightly larger than the head and is not designed to actually fit snuggly on the head. Rather it is designed to be slightly larger than the head, with about a one inch gap between the head and the inside padded portion of the support halo. This is so that the occupant can move his or her head in a relatively natural way. The occupant can turn the head, look up and down, all without conflicting with the support halo. Touching the head would be uncomfortable and increase the likelihood that a person, particularly a child, would try to squirm out of the halo. In one configuration the support halo is built on a rectangular frame with padding added, and a covering over the padding. When properly placed over the head there should be about an inch to two inches between the forehead and the front portion of the support halo, about one to two inches between the back of the support halo and the back of the head, and about one to two inches between the sides and the sides of the occupant's head. The support halo is configured to encircle the head of the occupant of the seat. It can be relatively square or rectangular in shape, or an oval shape that more closely follows the shape of the human head. In alternate configurations it can be somewhat “D” shaped, with the flat portion at the back of the head and the curved portion around the front of the head.

In some configurations the support halo is adjustable in size to properly fit around the occupant's head. There are a number of ways that the support halo can be adjusted in size. In one embodiment the support halo will be built on an adjustable frame and will have internal mechanisms to allow the physical size of the sides of the halo to be shortened or lengthened. In another embodiment the support halo will be one size, but will have removable internal padding to make the internal space smaller and fit more closely to the head of the occupant of the seat.

The purpose of the support halo is to protect the occupant's head and neck. In a vehicle crash the occupant of the seat will be secured in the seat. In a typical crash an unsupported head will move violently, resulting in a variety of injuries including whiplash and brain injuries. With the support halo in place, however, the occupant's head would move slightly, but not significantly. It is virtually impossible to prevent all injuries in a high speed crash, and the support halo certainly cannot claim to do so, but it should greatly minimize injuries by elimination the extreme movements of the head and the associated hyper-bending of the neck in a car crash. It should be noted that there can be unusual or excess head movement even in relatively low speed crashed, and this is particularly true with infants, small children, or infirm individuals who tend to lack neck strength.

A second purpose of the support halo is to dampen the head movement in the event of a crash. As noted above, it is possible that the brain can be injured by rapid acceleration or deceleration of the skull. The support halo cannot completely prevent head movement in the event of a crash, but it is designed to absorb most of the energy of the moving skull. The support halo has a number of energy absorbing components. The first energy absorbing layer is simple foam rubber or other common spongy material. This will provide a comfortable cushion for the head, but will also cushion minor head movements. If the head is moving more rapidly, for example in an automobile accident, the other energy absorbing components will come into play. Underlying the foam rubber will be a layer of Styrofoam® or extruded polystyrene foam, that will compress and absorb additional energy forces from the moving head. The support halo will be built on a frame or skeleton made of spring steel, and this will provide additional movement and shock absorption. Finally, the support halo will be attached to the seat by means of a configuration of posts, and these posts will have some play, which will allow some additional movement and absorption of energy.

While body and head movements are not as extreme in other situations such as an amusement park ride—primarily because the overall speed of the seat is not as high—excess head movement can still result in neck injuries. The incorporation of the support halo in the seats of such rides can significantly reduce the potential for such injuries. Additionally, the configuration of the support halo allows the occupant of the seat to have a nearly complete field of vision, and only slightly reduces range of motion, so it would not significantly take away the experience of the ride.

An additional benefit of the support halo is that it will protect the occupant's face from injury from an expanding air bag. Currently children in car seats are not supposed to be placed in the front passenger seat of a car due to the potential for injury from a deploying air bag. The support halo would provide a relatively rigid head and face protector to prevent injury from the force of a deploying air bag. One configuration of the support halo includes a crown protector, or a piece of material that covers the top of the support halo. The crown protector would provide additional protection from deploying air bags, as well as from any object that might be displaced in a crash and flying about the interior of a vehicle. In essence, the crown protector is a debris shield to protect the top of the head in a crash. The crown protector is particularly useful in the version of the support halo for infants or small children. Infants have soft spots on the head, known as fontanels. There are two fontanels, a small posterior fontanel on the back of the head that closes or solidifies at about six to eight weeks, and the larger anterior fontanel on the front of the head that closes or solidifies at eighteen to twenty four months. The crown protector will protect the fontanels from flying objects or deploying air bags.

The support halo is adjustably attached to the seat. It is important that the support halo be adjustable so that it can be properly positioned on the occupant's head. If it is placed to high it is possible for the occupants head to be forced under the halo in a high speed crash, and if it is too low it is possible for the occupant's face to impact the halo and cause facial injuries. Additionally, if the support halo is too low it will restrict the occupant's vision and will be awkward and uncomfortable for the occupant, which will increase the likelihood that the occupant will move out of it.

There are a number of potential configurations for this adjustable feature. In the configuration of the support halo attached to a child's protective car seat, the support halo movement mechanism rides in a series of parallel channels disposed within the seat back. The mechanism is lockable in position, so that the support halo can be secured in place once it is correctly positioned on the child riding in the seat. The movable feature allows the support halo to be moved up as the child grows, thus alleviating the need for purchasing a new car seat as the child grows. It is also possible to have a series of insert holes running up the back of the car seat with the support halo attached to the proper insert hole to position it at the appropriate height for the occupant. The embodiment of the support halo for a child's booster seat, or for a seat for special needs individuals, has a series of two parallel rails extending up from the back of the seat. The support halo is connected to the post by a mechanism that can move up and down the rails, and be locked into place. This allows the support halo to be moved up as the child grows. In the third embodiment the support halo is mounted on two parallel posts and the adjustment mechanism is integrated into the seat. In one configuration of this embodiment, the posts are the same size and are separated by the same spacing as the standard automobile head rest posts, and this allows the replacement of the standard automotive head rest with the support halo. It is also possible to have the post bent or even goose-necked to allow the support halo to be positioned below the back of the seat and to allow a smaller person, or a child in a booster seat, to use the support halo.

These mechanical adjustment mechanisms are designed to significantly reduce the chance, or ability, of a small child to try to move the support halo. One of the drawbacks of a number of prior art devices is that they attach to a seat by means of snaps or Velcro straps, which can be removed by the occupant, particularly a fussy child. This problem is eliminated by the use of mechanical movement mechanisms with locking devices.

In various embodiments, the support halo can also include a hinge to rotate all or part of the support halo up and down to make it easier to place a child into the seat. In one configuration the hinge will be at the back of the support halo, at the movement mechanism, so that the entire halo can flip up and down. This will allow the parent to rotate the support halo up, lock it into place, place the child into the seat, and flip down the support halo and lock it into place. In most instances the parent will properly adjust the support halo once to the proper child's head location, and when removing the child from the seat will simply flip up the support halo and lock it in the up position. Then when returning the child to the seat the parent will only need to flip the support halo down. Every few months, as the child grows, the support halo will need to be repositioned by means of the movement mechanism. In another configuration the hinge will be integrated into the side of the support halo, which will allow the front portion to be flipped up to open, thus allowing the parent to place the child's head into the support halo.

The support halo described so far is used primarily as a safety device to protect the head and neck in the event of a crash. But due to the configuration of the support halo, the device can also be used to stabilize the head in a rapidly or violently moving vehicle. The encircling head restrain that is attached to the seat in a vehicle can protect the head from excess movement due to a crash, but will also keep the head essentially in place during other rapid or extreme movements. The most obvious example would be a vehicle moving rapidly over uneven grounds, such as a jeep or all terrain vehicle, a tank, or a military personnel vehicle. In all of these situations the rapid movement of the vehicle over uneven ground causes rapid, jarring and multidirectional movement of the body and the head. Generally the body will be strapped into the vehicle through common seat belts or other restraints, but the head will be unconstrained. The addition of a support halo would allow some movement for the head but would control the movement within a small space. This would be of particular use where the occupant of the vehicle is required to perform certain functions that require the head or eyes. One example would be the gunner or fire control officer in a tank, who must visually aim the tank weaponry—gun or cannon—often while the tank is moving rapidly over uneven ground. The support halo would allow the gunner to keep his or her head in a relatively stable position in relation to the body, and would thus aid the gunner in aiming and firing the weapon.

There are a number of alternate embodiments of the support halo. In one embodiment the support halo would have an automatic movement control, much like many automatic headrests. The support halo would be positioned by a series of motors, and would have a pre-set location, which would allow the support halo to be automatically positioned once the pre-set location was established. It is also within the conception of the invention to include a variety of supporting features to the support halo and integrated support halo and car seat. For example, it is possible to incorporate a sun visor on the front of the support halo, as well as sun shades on the sides. It is also within the conception of the invention to incorporate air bags into the support halo or the combined support halo and car seat. Cars are increasingly equipped with more and smaller air bags, and it is within the conception of the invention to equip the support halo, or the integrated car seat and support halo with small air bags to provide additional protection for the occupant of the seat. It is also possible to include a face screen that would deploy in the event of an accident to protect the face of the occupant from injury. The face screen would deploy based on the same technology as standard automotive air bags.

It is possible, and within the conception of the invention, to incorporate any number of additional devices within the support halo and integrated seats. In fact, the configuration of the support halo near the head of the occupant of the seat makes it ideal for the incorporation of a number of ancillary devices. A wide variety of attachments for entertainment and educational systems can be incorporated. These could be built in to the seat or the support halo, and the car seat portion could be equipped with AC or DC power connection and basic entertainment connections, such as through a standard USB connector or other standard connectors for automobile entertainment systems (either audio or video), or other standard communication devices. There could conceivably be small speakers mounted in the head support near the ears, much like some automobiles have small speakers mounted in the head rest.

It could also be possible to incorporate solar power technology to an exposed portion of seat, since seats commonly sit in the car and are often sitting in the sun for extended periods of time. With the proper orientation of small solar panels this would easily charge a battery for use for small electronic devices. It is also conceivable that a small television screen could be incorporated into the device (either in the headrest or in a lower part of the seat.)

While the support halo and the integrated child safety seat and support halo are described for use in an automobile, it is possible, and within the conception of the invention, for the support halo to be used in the seat of any moving vehicle, including for example boats, trains, busses, and airplanes. The child restraint system can be used or specially designed for use for special needs individuals in public transportation and vehicles designed for the transportation of special needs individuals. In those situations, the configuration of the support halo near the head lends itself easily to the incorporation of medical devices within the seat. For example the support halo could easily include attachments for IV drips, supports for an oxygen supply, connections and supports for medical monitoring equipment, or a variety of other medical devices.

The child restraint system can also have a number of attachments or specially designed components, such as drink holders for children or specially designed drink holders for individuals that are physically and or mentally impaired or that have special needs. This type of drink holder could have a holder for the bottle contained in the body of the seat with a tube running up the support halo attachment components to provide a drinking tube for the occupant. Other compartments integrated within the seat could hold extra batteries, medications, remotes or any item that may benefit the occupant. In addition, such additional safety features, such as a Lojack type tracking device or GPS system, could be attached to the seat for tracking the seat in the event of an abduction or accident. In some configurations the system could also have a retina scanner or face recognition scanner for identification of the occupant and automatic adjustment for fit and support.

### BRIEF DESCRIPTION OF THE DRAWINGS

FIG. 1A is a perspective view of the support halo extending from the back of a standard car seat.

FIG. 1B is a detail of the attachment and movement mechanism for connecting the support halo to the car seat.

FIG. 1C is a top view of the mounting mechanism for connecting the support halo to the car seat.

FIG. 2A is a perspective view of the support halo incorporated into a child protective car seat.

FIG. 2B is a second perspective view of the support halo and child protective car seat showing the attachment and movement mechanisms connecting the support halo to the car seat.

FIG. 2C is a front elevation view of the underlying structure of the car seat showing the arrangement of the channels in the car seat frame.

FIG. 2D is an exploded perspective detail showing the attachment and movement mechanisms for the child protective car seat.

FIG. 3A is a perspective view of the support halo extending from behind the back of a child's booster seat.

FIG. 3B is a perspective view of the support halo extending from the back of a child's booster seat.

FIG. 3C is an exploded detail view of the attachment and movement mechanisms for connecting the support halo to the child's booster seat.

FIG. 4 is a perspective view of the support halo with the goose neck post attachment to a seat.

FIG. 5A is a perspective view detail of the support halo.

FIG. 5B is a sectional view showing the padding of the support halo.

FIG. 6A is a perspective view of the internal components of the support halo.

FIG. 6B is a detail of the side brace of the internal component of the support halo.

FIG. 6C is a detail of the rod component of the side brace.

FIG. 7A is a perspective view of the support halo with attachable pads.

FIG. 7B is a detail view of multiple attachment pads.

FIG. 8A is a perspective view of an alternate embodiment of the support halo on a child's car seat.

FIG. 8B is a second perspective view of the frame of the child's car seat with the alternate embodiment of the support halo attached.

FIG. 8C is perspective view of the alternate embodiment of the support halo in the raised position.

FIG. 8D is a perspective detailed view of the alternate embodiment of the support halo.

FIG. 8E is an exploded detail of the alternate embodiment support halo.

FIG. 8F is an exploded detail of the alternate embodiment support halo showing the rotation and locking mechanisms.

FIG. 8G is a detailed perspective view of the alternate embodiment support halo in the raised position.

FIG. 9 is a front elevation view of the support halo positioned on the head of the occupant of a seat.

FIG. 10 is a side elevation view of the support halo positioned on the head of the occupant.

FIG. 11 is a top plan view of the support halo positioned on the head of the occupant.

FIG. 12 is a perspective view of a support halo with a strip version crown protector.

FIG. 13 is a perspective view of a support halo with a cover version crown protector.

FIG. 14 is a side elevation view of one embodiment of the hinge mechanism located in the support halo attachment.

FIG. 15 is a side elevation view of one embodiment of the hinge mechanism located in the side of the support halo.

### DETAILED DESCRIPTION OF THE INVENTION

Detailed embodiments of the present invention are disclosed herein. It is to be understood that the disclosed embodiments are merely exemplary of the invention and that the invention may be embodied in various and alternative forms. Therefore, specified structural and functional details disclosed herein are not to be interpreted as limitations, but merely as a basis for the claims and as a representative basis for teaching one skilled in the art to variously employ the present invention.

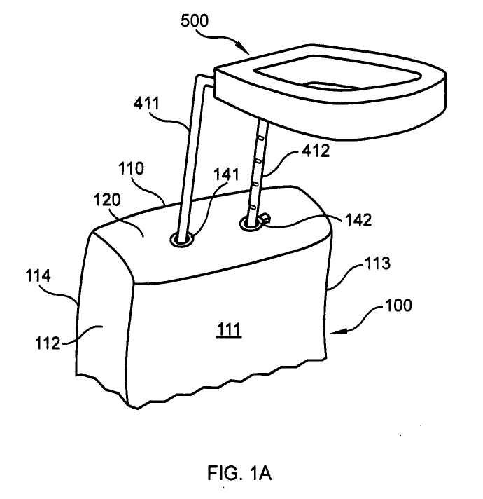

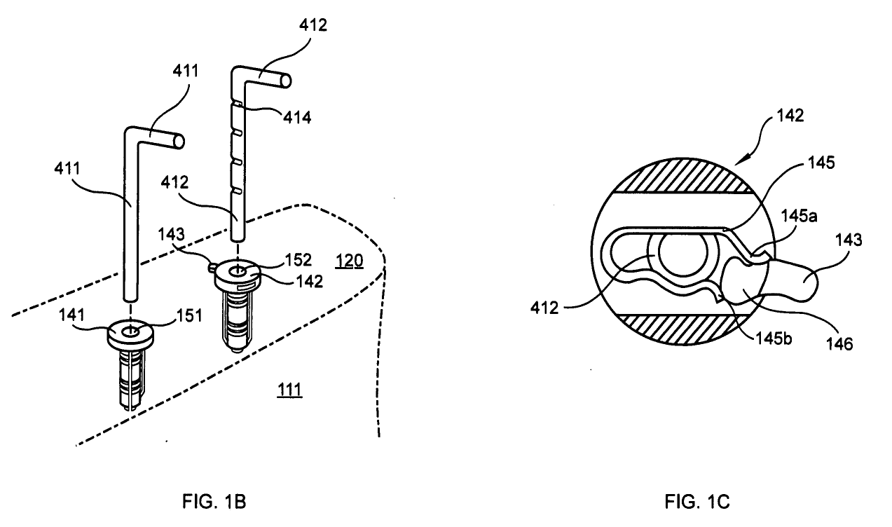

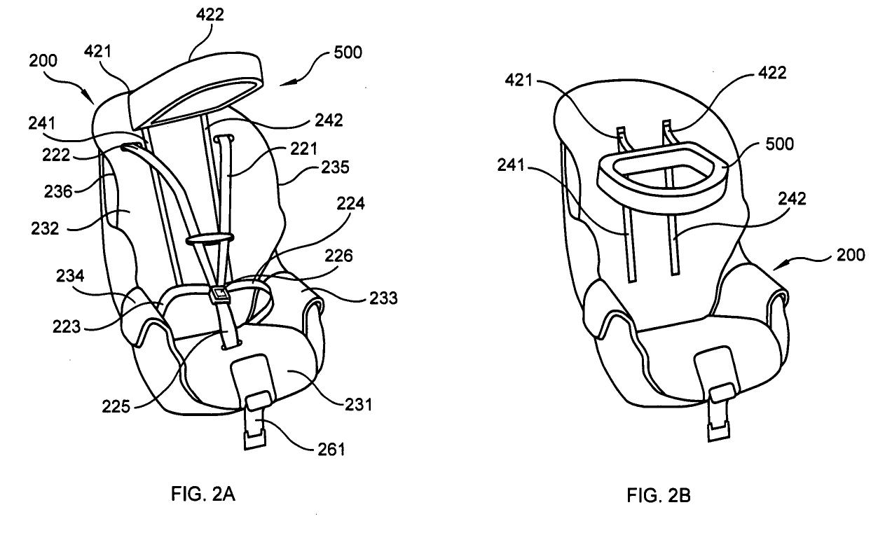

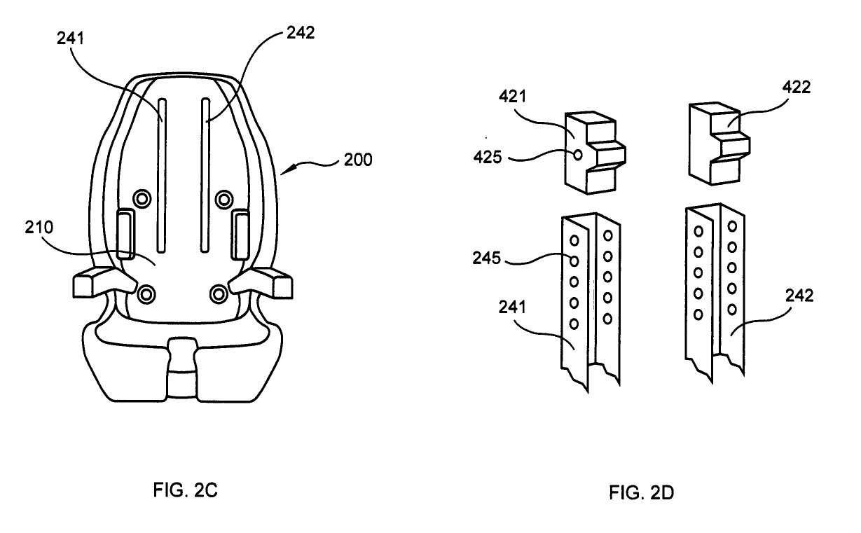

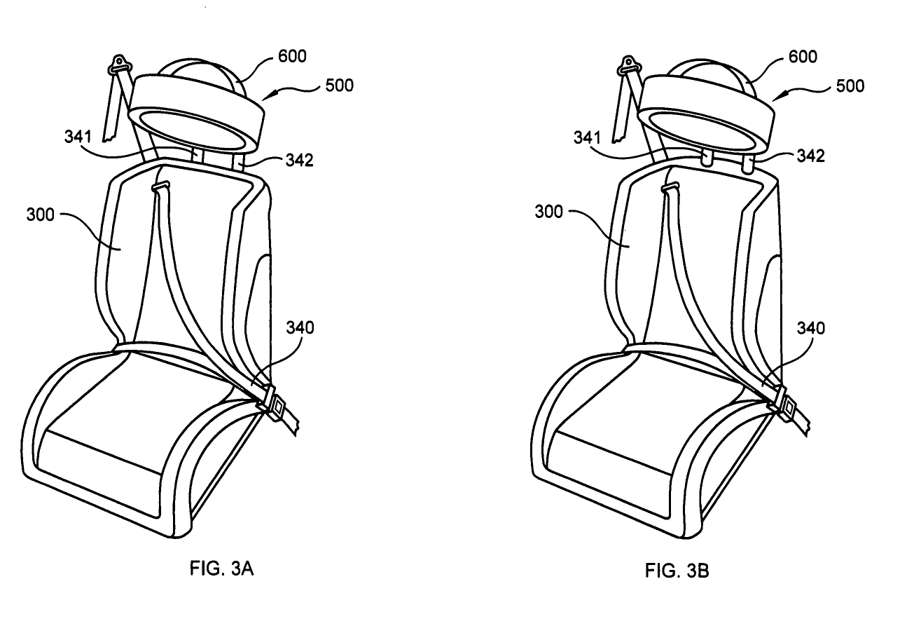

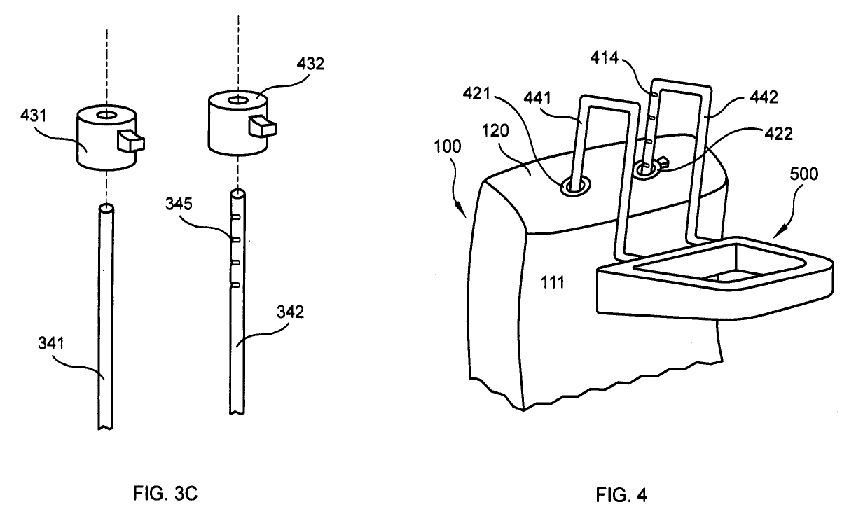

The invention comprises an encircling head support and restraint attached to the seat of a moving vehicle. FIGS. 1A, 2A, 2B, 3A & 3B depict the most common embodiments of the disclosed invention. FIG. 1A depicts the support halo 500 attached to a standard automobile car seat 100. FIGS. 2A & 2B depict the support halo 500 attached to a typical child protective car seat 200. FIGS. 3A & 3B depicts the support halo 500 attached to a typical child's booster seat 300. There are minor variations of the specific configuration of the support halo, and three common configurations are depicted in FIGS. 1A, 2A, 2B, 3A & 3B. FIG. 1A depicts the support halo 500 as roughly square or rectangular in shape. FIGS. 2A & 2B depict the support halo 500 with a curved front portion and in a configuration which, from above, roughly resembles the shape of a capital “D” with the curved portion at the front of the head of the occupant of the seat. FIGS. 3A & 3B depicts the support halo 500 in a roughly oval configuration, where the sides and back are curved to approximately conform to the roughly oval shape of the human head. The main components of each configuration are essentially the same, and any variations will be described in detail below.

FIG. 1A is representative of the support halo 500 attached to a typical automobile car seat 100. Head rests are required standard safety features in all new cars. FIG. 1A shows the support halo 500 replacing the standard head rest. Typical car seats 100 are well known, and have padding built over a frame. Car seats 100 have a seat portion (not show) and a seat back 110 which consists of the seat back surface 111 over the frame, and on which the seat occupant O places his or her back, two sides 112 & 113, a rear portion 114 (obscured in drawing), and an upper surface 120. Built into the seat back 110 at the upper surface 120 are two adjustable mounts 141 & 142. Typically, a head rest on mounting poles is inserted into the adjustable mounts. A representative configuration of such a mounting system can be seen in U.S. Pat. No. 5,816,658 to Wallis. One of the mounts has a lock to allow adjustment of the head rest and to lock it into place.

In one embodiment of the disclosed invention, the support halo 500 is attached to two mounting posts 411 & 412 which, as shown in FIG. 1A, are inserted into the corresponding adjustable mounts 141 and 142, such that mounting post 411 is inserted into adjustable mount 141, and mounting post 412 is inserted into adjustable mount 142. Each adjustable mount 141 & 142 has a corresponding central bore 151 & 152 with in internal diameter just slightly larger than the external diameter of the mounting posts 411 & 412, such that the posts 411 & 412 slidably fit inside the central bore 151 & 152. Typically one of the mounting posts 411 & 412 has notches 414, which will interact with the internal prong of the mount to lock the posts 411 & 412 in place. In FIG. 1B mounting post 412 is shown with notches 414, which connect to the adjustable mount 142. FIG. 1C is a detailed sectional top view of adjustable mount 142. Adjustable mount 142 contains a lock clip 145 made of spring material and a locking latch 143 on a pivot point 146, such that when the lock latch 143 is manipulated it opens the lock clip 145 to allow the mounting post 412 to slide into the central bore 152. When the mounting post 412 is positioned properly, the lock clip 145 will engage the appropriate notch 414 and spring back into position to lock the mounting post 412 into place. This allows the support halo 500 to be adjusted up and down through the mounting posts 411 & 412 and adjustable mounts 141 & 142 to place the support halo 500 in the proper position on the head H of the occupant O of the seat. Proper positioning of the support halo 500 on the occupant's head H will be described in detail below.

FIGS. 2A & 2B depicts a support halo 500 for use with a typical child protective car seat 200. The support halo 500 and child protective car seat 200 depicted in FIGS. 2A & 2B is the most preferred embodiment of the disclosed invention. Child protective car seats 200 come in many different shapes and configurations, and the car seat 200 depicted in FIGS. 2A & 2B is representative only. FIG. 2A is a perspective view showing the support halo 500 on the child protective car seat, but highlighting the common features of the standard child's car seat. FIG. 2 B is a perspective view from a different angle, showing the support halo 500 and related attachment hardware to connect it to the child protective car seat 200. Such child protective car seats 200 are well known, and are now required by all states for all children under a certain age. While there are many different configurations of child protective car seats, all share common features, and those representative features are depicted in FIG. 2A. Standard child protective car seats 200 are generally constructed of a solid frame 210 (shown in detail below in FIG. 2C) with padding 250 over the frame 210. The interior portion of the protective car seat 200 include a seat bottom 231, a seat back 232, a left arm rest 233 and a right arm rest 234, and a left extended side 235 and a right extended side 236. Most modern seats also include a special LATCH® mount 261 that connects to a corresponding latch clip on the automobile seat. A child occupant O (not shown in this figure) is typically placed in the car seat 200, and the arm rests 233 & 234 and extended sides 235 & 236 keep the child within the confines of the seat 200. The child occupant O is restrained in the seat by a standard seat and shoulder belt configuration, which consists of two shoulder straps 221 & 222, two lap belts 223 & 224, and a crotch strap 225. In most configurations there is a buckle 226 attached to the crotch strap 225, and the shoulder straps 221 & 222 and lap belts 223 & 224 connect into the buckle 226 to secure the occupant O into the seat 200.

Details of the connection between the support halo 500 and the child protective car seat 200 are disclosed in FIGS. 2C, 2D & 2E. The support halo 500 is movably attached to the protective car seat 200 by means of two sliders 421 and 422 that are rigidly attached to the support halo 500. The sliders 421 and 422 are disposed within the two channels 241 & 242 which are mounted in the protective car seat 200, with slider 421 sliding in channel 241 and slider 422 sliding in channel 242. As seen in FIGS. 2C & 2D, the channels 241 & 242 are mounted parallel in the back portion of the frame 210 of the car seat 200. The channels 241 and 242 are incorporated within the frame 210 such that they are flush with the back of the frame 210 so that they do not press against the back of the occupant O of the car seat 200. Typically the frame 210 of a car seats is made from a molded plastic and it is common for various components to be molded into the plastic. Various metal connectors are commonly molded into the frame 210 by a variety of measures. It is fairly common to incorporate the metal component into the mold before the molten plastic is injected, and in that way the metal component is formed directly into the plastic of the frame 210. Another common method for constructing metal components into the plastic frame 210 is to have an insert space molded into the frame and then insert the component into the insert space. Either method is acceptable for incorporating the two channels 241 & 242 into the frame 210. FIG. 2D is a sectional side view showing that the channels 241 & 241 are mounted flush with the back of the frame 210.

FIG. 2E is an exploded detail of the channels 241 and 242, and the corresponding sliders 421 & 422 that ride in the channels 241 & 242. At least one channel, shown as 241 in FIG. 2 E, has a series of holes 245 along the side of the channel, and the corresponding slider 421 has a button 425 that engages the holes 245 in channel 241 to lock the slider 421 in place on the channel 241 so that the support halo 500 can be positioned on the head H of the occupant O of the car seat 200. There are a number of common ways to manipulate this locking mechanism, but the use of a movable button 425 is shown for illustrative purposes. Typically there is a spring (not shown) under the button 425 that allows the button 425 to move out of the way and to allow the slider 421 to be moved up or down in the channel 241. When the desired position is found, the button 425 is released and the button 425 engages the hole 245 to lock the slider 421 in place. It is to be understood that there are many other types of moving and locking mechanisms that are well known in the art, and that can be used to position and lock the sliders 421 & 422 in the channels 241 & 242.

Padding 250 for car seats is well known and is designed and sewn to fit over the frame 210 of the seat 200. In seats 200 of the disclosed invention, the padding will require two parallel slits 251 & 252 that will correspond to the channels 241 & 242. When the padding 250 is placed over frame 210, the slit 251 will be over the channel 241 and the slit 252 will be over the channel 242. This will allow access to the channels 241 & 242, and allow the respective sliders 421 & 422 to extend out from the padding 250.

FIGS. 3A & 3B depict the third common configuration, which comprises the support halo 500 movably attached to a child booster seat 300. There are a number of different configuration of booster seats 300, and the seat depicted in FIGS. 3A & 3B are representative only. Some are similar to large protective car seats 200, with arm rests and side extensions, and others are essentially padding formed into a seat shape so that the child occupant O can use the automobile's standard seat and lap belt. In either case, the child is generally larger that the infant or small child that rides in a protective car seat 200, and the child's head H typically protrudes above the back 332 of the booster seat. The booster seat 300 shown in FIGS. 3A & 3B is a small seat that sits on the standard seat of the automobile and is attached by means of the conventional seat belt 340 of the automobile. In this configuration the support halo 500 attaches to the booster seat by a series of support rails 341 & 342 that extend up from the back of the booster seat 332. FIG. 3A shows the support rails 341 & 342 attached to the back of the booster seat 300, and FIG. 3B shows the support rails 431 & 342 integrated into the body of the booster seat 300. In either configuration the support rails 341 and 342 extend parallel up from the back of the booster seat 300. The variant depicted in FIG. 3A can be factory installed equipment, or can be an after-market add-on that is simply bolted to the back of the booster seat 300.

The support halo 500 in FIGS. 3A & 3B is depicted as an essentially oval or round in shape. It is to be understood that the support halo 500 can be many different configurations but it designed to constrain the head. As a result it will be shaped to some degree to conform to the shape of the head. As shown in FIG. 3C, the support halo 500 of is attached to two movable collars 431 & 432, and the moveable collars 431 & 432 are mounted onto the corresponding support rails 341 & 342. The movable collars 431 & 432 slide on the support rails 341 & 342 to allow the proper positioning of the support halo 500, as described in more detail below. At least one of the support rails 341 or 342 has a series of notches 345, and at least one of the moveable collars 431 or 432 has a latching mechanism to engage the notches 345 to secure the movable collars 431 or 432 in place and thereby secure the support halo 500 in place. The latching mechanism of the movable collar 431 or 432 is similar to the lock clip mechanism of the adjustable mount 142 described above.

Standard booster seats 300 typically restrain the child occupant O by means of the car's standard seat belt 340. In one embodiment, the booster seat 300 will contain an additional shoulder harness (not shown) to more fully secure the occupant O into the seat. This is because the standard seat belt does not always fully restrain the occupant O. In some cases the occupant's body will shift, since the standard seat belt 340 shoulder restraint is only on one side of the body. This allows the unrestrained side of the body to move more than the restrained side of the body. While this configuration of seat belt provides substantial protection in an accident, it may not be sufficient to restrain the body with the support halo 500 in place, and could possibly produce excess strain on the occupant's neck. As a result, additional restraints may be required and are within the conception of this invention.

FIG. 4 is a depiction of an alternate embodiment of the support halo 500 attached by goose neck posts 441 & 442 to a seat back (100 or 300). This configuration can be used with either the standard automobile car seat 100 or a booster seat 300 and will allow the support halo 500 to be used with smaller occupants O. This configuration can also be used in a standard automobile car seat 100 with an occupant in a booster seat 300. This goose neck configuration will allow the support halo 500 to be positioned below the top or upper surface 120 of the back 111 of the respective seat. The goose neck attachments 441 & 442 are straight as they leave the mounts 421 & 422 on the back of the seat 110. This will allow the support halo 500 to be properly positioned on the head H of the occupant O of the seat 100. The goose neck attachments are then bent, as depicted in FIG. 4, so that the support halo 500 is positioned nearly adjacent to the back surface 111 of the car seat 100. FIG. 4 depicts the most preferable bending of the goose neck attachments 441 & 442. The goose neck attachments 441 & 442 are parallel and straight as they leave the mounts 421 & 422, then bent approximately 90 degrees to run essentially parallel with the upper surface 120 of the back of the seat 100, then bent approximately 90 degrees to run essentially down the back surface of the seat 111, and then another approximately 90 degree bend to position the support halo 500 slightly away from the back surface 111 of the seat 100, so that the support halo 500 is positioned slightly off the back surface. This, as described above, allows the head H of the occupant H of the seat 100 to have a natural slightly forward tilt. The goose neck attachments 441 & 442 mount into the adjustable mounts 141 & 142 as described above for the support halo 500 version in FIG. 1, and gooseneck attachment 442 has notches 414 that engage the locking mechanism described in FIG. 1B above.

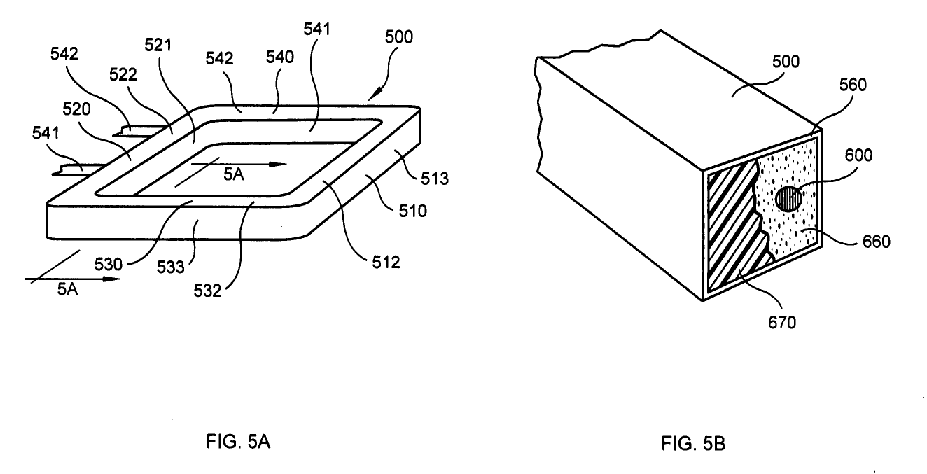

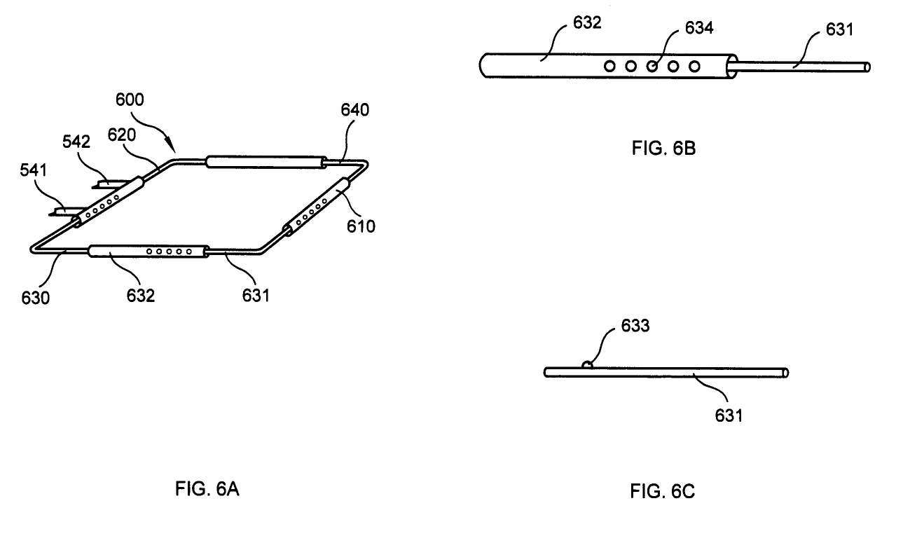

FIG. 5A is a perspective detail of the external configuration of the support halo 500, FIG. 5B is a sectional view showing the internal padding of the support halo 500, and FIG. 6A is a detail of the skeleton 600, or internal structure of the support halo 500. An understanding of all three is necessary to fully define the support halo 500. Padding 660 & 670 is formed over the skeleton 600 and a covering 560 is placed over the padding 660 & 670 to form the external portion of the support halo 500. The purpose of the padding is to absorb the energy of the excess or violent movement of the head H in the event of a crash. In the most preferred embodiment there are actually multiple layers of padding 660 & 670. A relatively rigid first layer of padding 660, which directly surrounds the skeleton 600, is made of Styrofoam® or extruded polystyrene foam, or similar material, and then on the inside areas of the support halo 500, a softer, spongier, second layer of padding 670, which is foam rubber, polyurethane foam or other soft and spongy material. The covering 560 can be made of cloth, leather, synthetic leather, and many other common automotive covering materials. The use of leather, or simulated leather-like materials, for car seats is well known. Leather is used because it is durable, soft, smooth, and does not heat up or cool down appreciably inside of a car. It is important that the support halo covering 560 be made of a light color material so that it does not become excessively hot, either while the car is unoccupied and sitting in the hot sun, or while in use. The second layer of padding 670 is on the interior portion of the support halo 500, and therefore adjacent to the head H of the occupant O of the seat 100, 200 or 300. The soft foam internal padding 670 will allow the occupant O to rest his or her head H comfortably against the support halo 500. This will allow the occupant O to rest the head H to sleep or simply to rest.

The multiple levels of padding 660 & 670 are also designed for energy absorption in the event of an accident or other sudden movements of the head H. If the head H moves suddenly it will contact the soft foam layer of padding 660. In many situations this soft padding 670 will be sufficient to absorb the energy of the moving head H, or to cushion the movement so that the head H is not injured. In the event that the head H is moving rapidly, such as during an automobile accident, the soft foam padding 670 will provide a first layer of energy absorption, but then the second layer 660 will provide a second layer of energy absorption. It is important that this second layer 660 be made of a semisolid but deformable material such as Styrofoam®, which will move some from the impact. In more extreme of violent impacts the second layer 660 will deform more, and may even break if deformed too much, but this breakage will also absorb energy.

The support halo 500 presented in FIG. 5A is representative only. It depicts the support halo 500 in a generally rectangular shape, but the support halo 500, as shown in previous figures, can be other shapes. The support halo 500 is designed to fit around the human head H, and the human head H is not precisely rectangular in shape. In general, however, most heads are slightly longer from front to back then they are wide, from side to side, so a padded rectangle is a fair approximation of the shape of the head. This is particularly true when the padding is considered. Most human shapes are not geometrically precise, but most furniture comes in relatively geometric shapes. A chair or sofa back is relatively flat, even though the human back is not flat. Support and comfort are achieved through the padding, which allows the uneven human shape to conform to the shape of the article of furniture. More precisely, of course, the padding allows the relatively geometric article of furniture to conform to the relatively uneven shape of the human anatomy. The same holds true for the padded interior portions of the support halo 500. The rear pad 520 may be relatively flat, but since it is padded it is comfortable for the human head H despite the fact that the back of the head is somewhat curved.

In alternate embodiments the support halo 500 can have curved portions to more accurately conform to the shape of the head H. Generally the front of the head and the back of the head are more curved, and it is possible to curve the front pad 510 and the back pad 520 to more closely conform to the shape of the head. Regardless of the actual shape of the support halo 500, it will have the same basic components disclosed in FIG. 5A. The support halo 500 consists of a front pad 510 attached to a right pad 530, which is attached to a rear pad 520, which is attached to a left pad 540, which is attached to the front pad 510 to make a complete structure that will encircle the head H of the occupant O. Each side of the pad has a top, an inside, an outside and a bottom portion, so, for example, the left pad 540 has a left pad top 542, a left pad bottom 544, a left pad inside 541 and a left pad outside 543. Similarly, the right pad 530 has a right pad top 532, a right pad bottom 534, a right pad inside 531 and a right pad outside 533; the front pad 510 has a front pad top 512, a front pad bottom 514, a front pad inside 511 and a front pad outside 513; and the rear pad 520 has a rear pad top 522, a rear pad bottom 524, a rear pad inside 521 and a rear pad outside 523. The front pad inside 511, read pad inside 521, right pad inside 531 and left pad inside 541 create an inside pad circumference 501.

FIG. 6A shows the internal skeleton 600 of the support halo 500. The internal skeleton 600 is made up of four interconnected braces, a front brace 610, which is connected on one side to a right brace 630 and on the other side to a left brace 640, and both are connected to a rear brace 620. In one configuration the braces 610, 620, 630, & 640 are made from a solid piece of strong material, such as steel or hardened plastic. The material needs to be of sufficient strength to stop the movement of a head H in the high speed of an automobile accident. Steel is idea since it is strong, but also has some give or springiness, which will provide an additional level of shock absorption during an accident. Mounting attachments 541 & 542 are connected to the rear brace 620. The mounting attachments 541 & 542 can be attached to the rear brace 620 in a variety of conventional manners, such as with screws or bolts, gluing, welding or in some configurations can be made from a single piece of material as the rear brace 620.

As can be appreciated, because the completed support halo 500 is padding built over the skeleton 600, it will be essentially the same shape and configuration as the skeleton 600. FIG. 6A depicts an essentially rectangular skeleton 600, but as described above, the braces 610, 620, 630, & 640 can be curved slightly, which will give the support halo 500 with padding 505 a slightly rounded shape. In the embodiment of FIG. 6A, the skeleton 600 is adjustable in size, but in alternate configurations, such as the rounded or oval shaped support halo 500 as depicted in FIGS. 3A & 3B, the skeleton 600 could be made from a single piece of material. Those alternate configurations would still have padding 660 & 670.

In the embodiment depicted in FIG. 6A, the braces 610, 620, 630, & 640 are designed to be adjustable. This will allow the user to adjust the size of the support halo 500 to accommodate different size heads, and will also allow the support halo 500 to be enlarged slightly as the head H of the child occupant O grows. As shown in FIGS. 6B & 6C, each brace 610, 620, 630 & 640 is comprised of a rod that is slideably and fixedly mounted inside a tube. So, by way of example, the right side brace 630 is comprised of a right rod 631 that slides into the right side tube 632. Detail FIG. 6B shows a representative rod 631 inserted into the open end of the side tube 632. The closed end of the side tube 632 is fixedly attached to the side brace 630. The rod 651 has a spring mounted button 633 located near the end of the rod 631. The tube 632 has a series of holes 634 that are separated by approximately one quarter to one half an inch. When the rod 631 is slid into the tube 632 the spring mounted button 633 engages one of the holes 634. The position of the rod 631 is determined by the placement of the spring mounted button 633 in the hole 634 in the tube 632. Detail FIGS. 6B & 6C show one possible engagement mechanism, but it is within the conception the invention to have any form of size adjustment mechanism in the support halo 500. It is possible, for example, to have a pin extending from the outside of the support halo 500 that can be pulled out to adjust the position of the rod 631. Because of the configuration of the skeleton 600 the tube and rod assembly of the left side brace 640 and right side brace 630 must operate in conjunction. In the same manner the tube and rod assembly of the front brace 610 and rear brace 620 must operate in conjunction. In this configuration there is sufficient give in the covering 560 and padding 660 & 670 to allow some minor adjustment of the size of the support halo 500.

In one embodiment the braces 610, 620, 630 & 640 are made of spring steel, which will allow some give of the skeleton 600. This will allow some movement of frame in the event of an accident. In alternate embodiments the braces 610, 620, 630 & 640 can be made of any suitably strong, yet flexible material. This could be a variety of metals, as well as many modern plastics, which have a good strength to flexibility ratio. The skeleton 600 and braces 610, 620, 630, & 640 are depicted as having essentially circular cross sections, but this is representative only, and it is to be understood that the skeleton 600 can be made from a variety of strong, durable and springy material having a variety of possible cross sections, including but not limited to rectangular and flat.

The rear tube 622 is connected to two mounting attachments, a right mounting attachment 541 and a left mounting attachment 542. The mounting attachments 541 & 542 are rigidly and securely attached to the rear tube 622 and are thus securely attached to the internal skeleton 600 of the support halo. The mounting attachments 541 & 542 are connected to the respective attachment and movement hardware that allows the support halo 500 to be movably attached to the seat. In the configuration of the support halo 500 connected to a standard automobile seat, the mounting attachments 541 & 542 are attached to the mounting poles 411 & 422. In the configuration of the support halo 500 movably connected to a child protective car seat 100, the mounting attachments 541 & 542 are attached to the sliders 421 & 422. In the configuration of the support halo 500 movably attached to the booster seat, the mounting attachments 541 & 542 are attached to the movable collars 431 & 432. In the preferred embodiment of each configuration, the mounting attachments 541 & 542 are formed of the same piece of material as the respective seat mounting device. So, for example, the mounting attachment 541 is made from the same single piece of metal as mounting pole 411. The same is true for all other respective mounts. In alternate configurations the mounting attachments 541 & 542 can be bolted, spot welded, or attached by screws or attachment plates to the respective movement mechanisms, 411 & 412, 421 & 422 or 431 & 432.

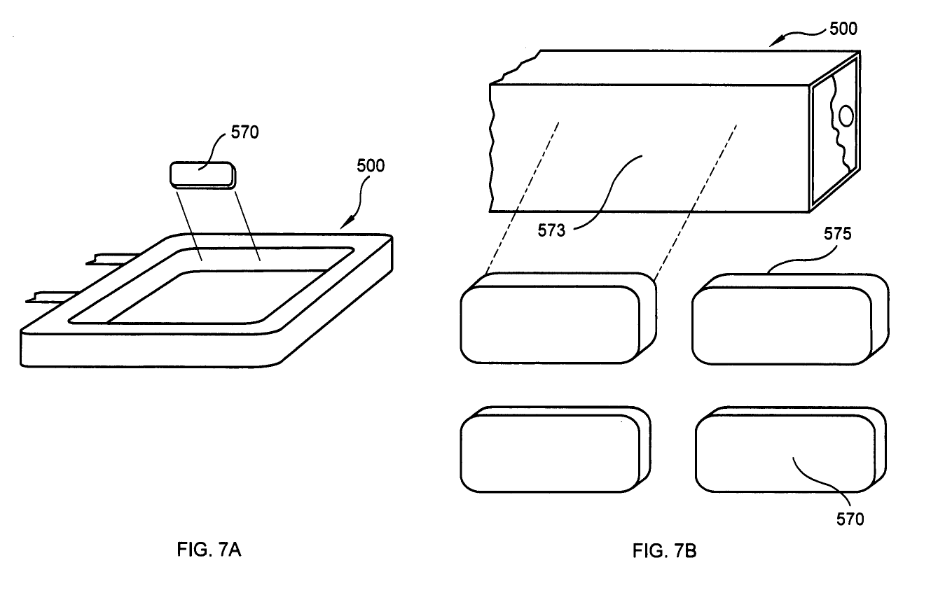

In an alternate embodiment of the support halo 500, as shown in FIGS. 7A & 7 B, the adjustable feature of the sizing of the support halo 500 can be achieved by a series of attachable pads 570. In this configuration the braces 610, 620, 630, & 640 do not include the adjustable features of the corresponding rods and tubes, but are made from a single piece of suitable material. This embodiment will include the first layer of padding 660 formed over the skeleton 600 and a second layer of padding 670 over the first layer 660 on the insides of the support halo 500. In this embodiment the covering 560 will be made of a cloth material, and the attachable pads 570 will have sections of connecting material 575 made of material such as Velcro®. Velcro® is well known, and comprises a tight hook and loop material that will readily adhere to many types of cloth material. The cloth material of the covering 560 will be made of the type of material readily adherable by Velcro®.

There are at least two reasons for this adjustable feature of the support halo 500. One reason is that a child's head grows as the child grows, and having the support halo 500 adjustable, will allow the use of the same support halo 500 for a number of years while the child grows. It is not uncommon for a parent to use two, and in some cases three, child car seats during the time that the child is required to ride in car seats. Often the parent will have a small, or very small car seat when the child is an infant, a second seat when the child is a toddler and a third seat when the child is older but not quite large enough for a booster seat. In this situation the new seats would also have support halos 500, which would be larger for each size car seat. But during the time when a child is in one car seat the child will continue to grow. Virtually all car seats now have a variety of adjustable features which allow the parent to adjust the seat belts and shoulder harnesses to the growing child. The moveable feature of the support halo 500 is designed for this purpose as well. The support halo 500 can be moved up the channels 421 & 422 to accommodate the growth of the child. The addition of an adjustable support halo 500, also allows the parent to adjust the support halo 500 as the child grows. Adjustability of the support halo 500 is also necessary to accommodate different clothing that a child might wear in different weather. In the summer a child will most likely be bareheaded, while in the winter the child might wear a hat of some type or head coverings such as ear muffs. It would be inconvenient and unduly expensive for a parent to have to purchase a second support halo 500 for use during the winter months if the child wears a bulky winter hat.

A typical support halo 500 would include a number of different size and thickness attachable pads 570. The parent would size the inside circumference 501 of the support halo 500 by the addition of removal of the attachable pads 570. Similar pads are commonly used in bicycle helmets, batting helmets, hockey helmets or other protective sports helmets. The user simply adds layers of attachable pads 570 to properly size the helmet.

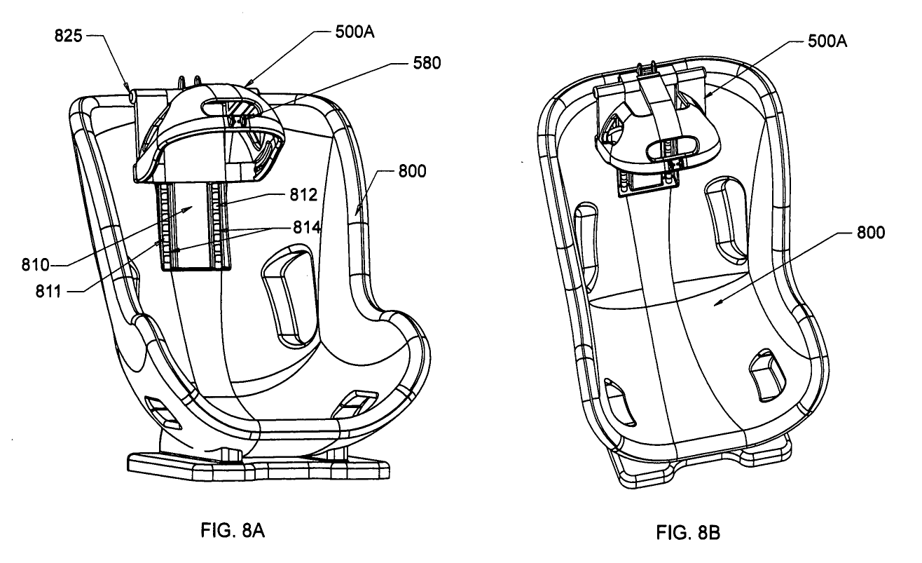

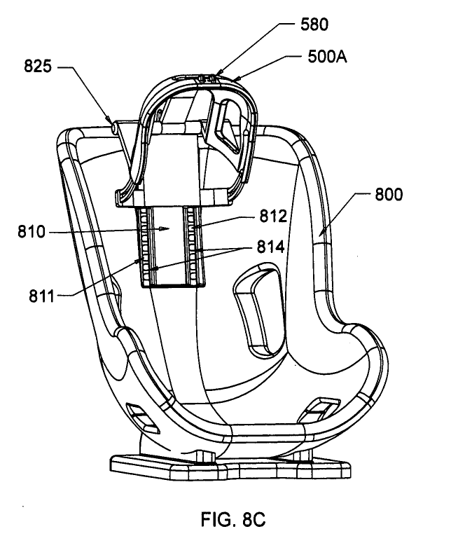

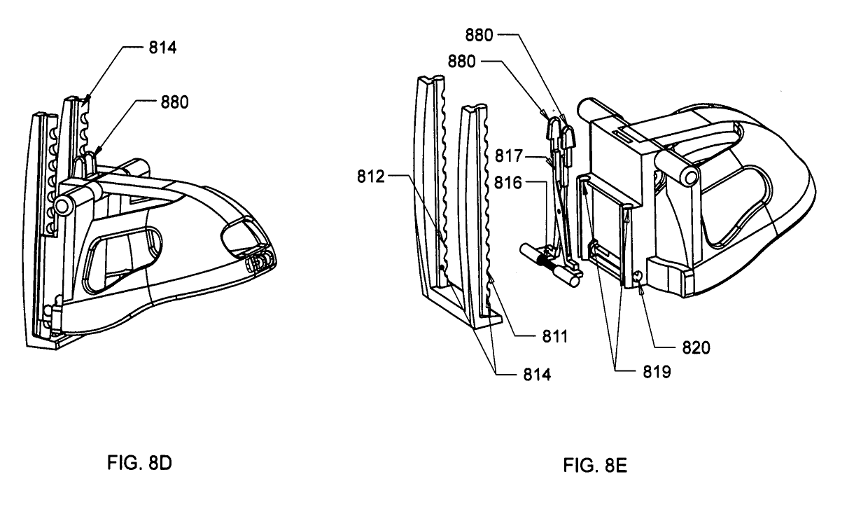

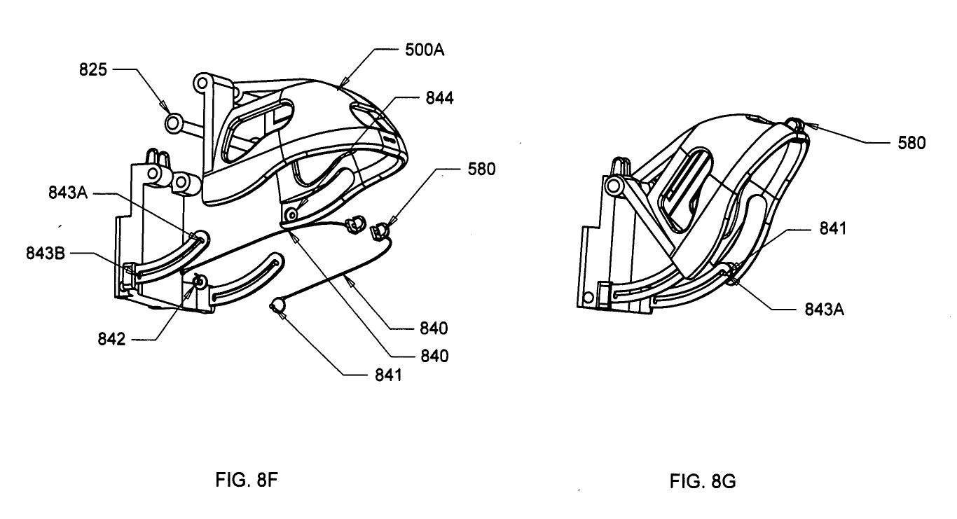

An alternate embodiment of a support halo 500A is depicted in FIGS. 8A to 8G. This support halo 500A is mounted in a slightly different variation of the child's protective car seat 800. This type of “bucket” child protective car seat 800 is commonly used for much smaller children, but it is to be understood that this variation could be incorporated into any configuration of child protective car seat. In this variation the child's car seat 800 has two parallel guide rails 811 & 812 that are incorporated into the center of the back of the seat. The guide rails 811 & 812 are shown in more detail in exploded FIG. 8 E. The guide rails 811 & 812 have notches 814. A sliding plate 830 is attached to the back of the support halo 500A. The sliding plate 830 has two parallel molded cylinder cores 819 that are sized to slidably engage and slide on the two parallel guide rails 811 & 812, which allows the sliding plate 830, and the support halo 500A with it, to move up and down on the guide rails 811 & 812.

Mounted in the back of the sliding plate 830 is a two part scissor 817 with an integrated spring 816. At the top of the two part scissor 817 are two release tabs 880, and at the bottom of the two part scissor 817 are two locking pins 815. When the two release tabs 880 are squeezed together, the two locking pins 815 move inwards. The spring 816 generally forces the two locking pins 815 outward. The two part scissor 817 is mounted in the back of the sliding plate 830 such that the two locking pins 815 extend out of two molded holes 820 in the sliding plate 830. The two locking pins 815 engage the notches 814 of the two guide rails 811 & 812. The support halo 500A is positioned in the seat 800 by squeezing the release tabs 880, sliding the halo 500A up and down, and then releasing the tabs 880. When the tabs 880 are released, the pins 815 will extend, and will lock into the notches 814, and thereby lock the support halo 500A in place.

As shown in detail in the exploded view of FIG. 8 F, at the top of the slide plate 830 there is a plate pivot pin mount 835. At the top back of the alternate support halo 500A there is a halo pivot pin mount 585. A pivot pin 825 slides through the plate pivot pin mount 835 and the halo pivot pin mount 585 to hold the halo 500A in place. The alternate support halo 500A can rotate up around this pivot pin 825 to move the halo 500A up to allow a child occupant O to be placed in the seat 800.

The alternate halo 500A can be locked in the up and the down position through use of the pivot locking system shown in more detail in FIG. 8F. At the front of the halo 500A is a pivot lock release 580. There are two sides to the pivot lock release 580 mounted in a slot at the front of the halo 500A. There are two release cables 840 that attach to the pivot lock release 580. The two release cables 840 run in channels on the inside of the halo 500A. There is a pivot lock 841 at the other end of the release cable 840. Each pivot lock 841 is essentially circular, and each pivot lock 841 sits in a circular pocket 844 in the back portion of the support halo 500A. There is a torsion spring 842 that holds the pivot lock 841 in place within the circular pocket 844.

Two pivot guides 853 are mounted at the bottom of the sliding place 830. There are pivot guide channels 850 located in the bottom portion of the halo 500A such that the pivot guides 853 can slide in the pivot guide channels 850. The pivot guides 853 have a lock pin slot 843 and the pivot lock 841 runs in the lock pin slot 843. At the end of the lock pin slot 843 adjacent to the slide plate 830 there is a down position detent 843B, and at the other end of the lock pin slot 843 there is an up position detent 843A.

When the pivot lock release 580 is squeezed together, the release cables 840 pull on the pivot lock 841, which rotates in the circular pocket 844, thus rotating the pivot lock 841 out of the down position detent 843B. The halo 500A then can be rotated upward on the pivot pin 825. The pivot guides 853 will ride in the guide channels 850 and keep the halo 500A in position. When the halo 500A reaches the top, the pivot lock 841 will be forced back down by means of the torsion spring 842, and the pivot lock 841 will drop into the up position detent 843A, thus locking the halo 500A in the up position.

There is padding over the seat 800, as is common and well known in car seats designed for children. There are spaces or gaps in the padding on the back of the seat to allow for the placement of the parallel guide rails 811 & 812. Padding will also be added to the inside of the alternate support halo 500A to properly fit it around the head H of the occupant O of the seat 800. The alternate support halo 500A is positioned at the same location on the head H as the other embodiments of the support halo 500, and described below.

It should be appreciated that these two configurations are representative only of both the configuration of the head protecting halo itself, and the mechanisms for moving and adjusting the halo in the seat. There are, therefore, other possible ways to move the halo up and down the car seat. In one alternate variation the halo 500 has prongs, and there are related spaced holes running up the back of the car seat. The prongs of the halo can be inserted into the correct hole in the seat to provide proper up and down adjustment of the halo. In another configuration the halo is mounted on a rigid shaft that can be moved up and down. In this configuration the shaft can be threaded and the support halo can be moved up and down by turning a crank to move the support halo, much like a car jack can be moved up and down.

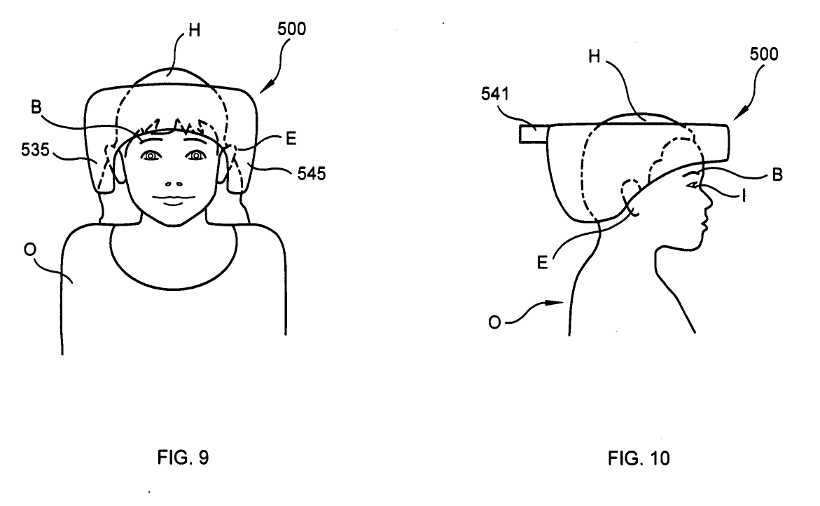

FIGS. 9, 10 and 11 depict the proper positioning of the support halo 500 on the head H of an occupant O of the seat 100, 200 or 300. The position of the support halo 500 on the occupant's head will be the same regardless of the occupant's size, head size, or the type of seat used. As a result the support halo 500 is show separate from any seat 100, 200 or 300. It should also be noted that the support halo 500 of FIGS. 9 & 10 is another variation on the shape and configuration of the support halo 500. In this version of the support halo 500 the left and right side pads 530 & 540 have extended ear protectors 535 & 545 that extend down below the ears E of the occupant O, to provide additional support and protection in the event of an unusual or rapid head movement.

FIG. 9 is a front view of the head H in the support halo 500, FIG. 10 is a side view, and FIG. 11 is a top view. As can best be seen in the top view of FIG. 10, there is a space between the head H and the inside pad circumference 501 of the support halo 500. This allows the occupant O to move his or her head H in a relatively unconstrained manner. This space allows almost near normal rotation of the head H from left to right, and allows the occupant to tilt the head H forward and back in a nearly normal manner and range. It is important to allow some movement of the head H. Holding the head rigid can cause neck fatigue and strain, and for small children, restraining the head will increase the likelihood that they will move their head H out of the confines of the support halo 500. In general, there should be a space of between one and two inches between the side of the head H and the associated inside pad of the support halo 500. Obviously during the time that the occupant O is in the seat 100, 200, or 300, he or she might rest his or her head H against the inside pad of the support halo 500, but in general there should be this space between the head H and the support halo 500. The proper space between the head H and the inside circumference 501 can be achieved through either of the two adjustment features mentioned above, either the insertion of additional attachable pads 570 or through manipulation of the braces 610, 620, 630 & 640 as depicted in FIGS. 6A, 6B & 6C.

The proper position of the support halo 500 on the head H of the occupant O of the seat 100, 200 or 300, can best be seen in FIGS. 9 & 10. The support halo bottom surface 504 should be positioned just above the ears E and eyebrows B of the occupant O. It should be understood that human heads are not uniform, and some people have eyebrows just slightly higher than the top of their ears, while others have eyebrows even or slightly below the level of the top of the ear. Additionally, some people tend to hold their heads tilted forwards, while others tilt the head slightly back. It is also understood that some people will slouch in the seat. This is particularly true with very small infants, who have little or no body or neck strength to sit erect. As a result there is no clear way to define one specific position for the support halo 500 on the head H of the occupant O. The adjustable nature of the support halo 500, however, allows the halo 500 to be moved to the location most suited for the occupant O. The key component is that the support halo 500 should be high enough so that it does not obstruct the vision of the occupant O (which might cause the occupant to try to remove the support halo 500) or so low that the head H would easily slip below the halo 500 in the event of a crash. A location at or near to the top of the ears E, and close to just above the eyebrow B has been shown to be the most comfortable and effective. If the support halo 500 is positioned much lower than the eyebrows it may begin to restrict the field of vision and limit the head movement. This will be an irritant to the occupant O, which could cause the occupant O to move in such as way as to minimize the effectiveness of the support halo 500. It is most likely that a poorly placed support halo 500 would increase the likelihood that small children would squirm out from under the support halo 500. On the other hand, if the support halo 500 is positioned much higher on the head H than just above the eyebrows B and the ears E it will not be in the proper position to stop the head H in a rapid movement.

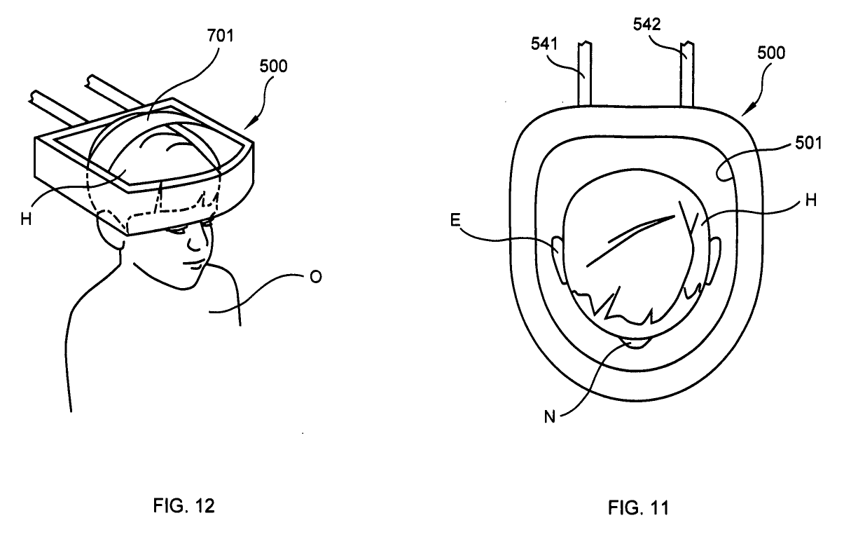

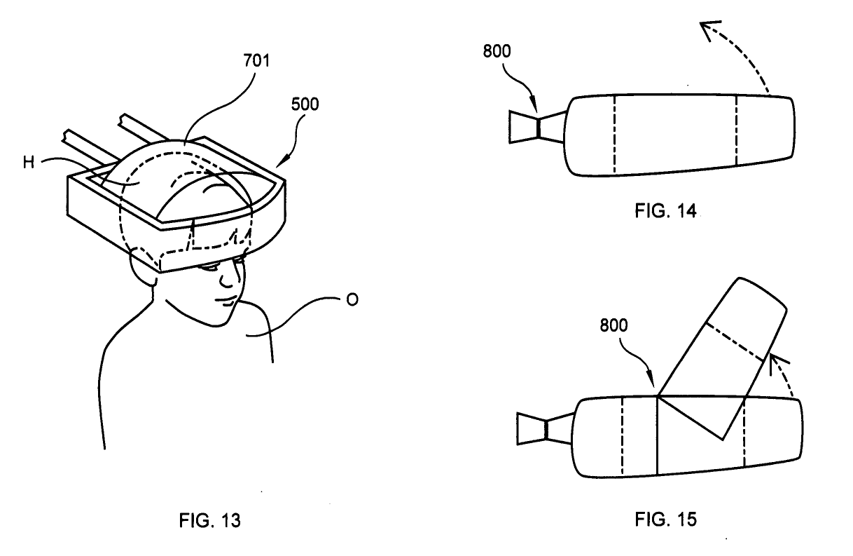

FIGS. 12 & 13 show the support halo 500 with an optional crown protector 701 or 720. In one variation, shown in FIG. 12, the crown protector 701 is a relatively narrow strap 610 that runs from the right side 530 to the left side 540 of the support halo 500, over the head H of the occupant O. The strap crown protector 701 can be made from a variety of rigid or semi rigid materials including leather, rubber, plastic or foam rubber covered with a plastic or leather material. The crown protector 701 of FIG. 12 is slightly curved so that it will bend up away from the top of the head H. The purpose of the crown protector 701 is to provide additional protection to the top of the head H during a crash, in particular to act as a debris shield to protect the top of the head H from objects that might be flying around in an accident. It should be pointed out that the crown protector 701 does not provide structural support, so it would not protect the head H in the event that the roof of the car is crushed down into the passenger compartment of the vehicle. Crown protector 701 of FIG. 12 is most appropriate for larger children or special needs adults.

The crown protector 702 of FIG. 12 can completely cover, or nearly completely cover, the opening at the top of the support halo 500. This crown protector 702 will also run from the right pad 530 over the top of the head H to the left pad 540. This configuration is most appropriate for infants and small children, particularly those under about two years of age where the fontanel has not fully closed. The full crown protector 702 will protect the top of the child's head H in the event of a crash particularly where there is flying debris such as glass produced by the impact of the crash. While it is conceivable, and within the conception of the invention, that the crown protector 702 will completely cover the head H, in the preferred embodiment there will be some space between the crown protector 702 and the support halo 500 to allow air to flow into the head to keep the head H cool.

Turning now to FIG. 14, in one embodiment of the support halo 500 there is a hinge 800 for moving the support halo 500. In the configuration shown in FIG. 14, the hinge 800 is located between the mounting attachments 541 & 542 of the support halo 500, and the corresponding movement mechanisms described above, either 411 & 412 if the support halo 500 is in use with a standard automobile seat 100, 421 & 422 if the support halo 500 is in use with a child protective car seat 200, and 431 & 432 if the support halo 500 is in use with a booster seat 300. The hinge 800 will simplify the use of the support halo 500. It will allow the occupant to get in and out of the seat without having to move his or her head around and under the support halo 500. In most cases the occupant O will sit in, or in the case of infants and small children be placed in, the seat 100, 200 or 300, and the support halo 500 will be rotated down on the hinge 800 and locked into place. Then, as described above, the support halo 500 will be placed in the proper position for use, and locked into place. When it is time to remove the occupant O from the seat, the support halo 500 can be moved out of the way by means of the hinge 800 rather than changing the position adjustments. FIG. 15 shows an alternate embodiment with the hinge 801 located in the side of the support halo. As can be appreciated, the hinge could conceivably be located in any position on the side between the front 510 and the back 520 of the support halo 500.

While not depicted in any drawings it is obvious that the integrated support halo 500 and car seat can include a number of common add-on items such as cup holders, storage bins or trays. This is particularly true for the variant of the child protective car seat 200 or booster seat 300. Many of these add-ons will be attached, or built into the child protective car seat 200 or booster seat 300. It is also possible to add a variety of clips to the support halo 500 for such common devices as iPod headphones. Because one configuration of the support halo is designed for use for special needs individuals who lack neck strength, it is well within the conception of the invention to include clips for external medical devices such as monitors, as well as for intravenous drips. It is also possible to add sun visors to the front portion of the support halo 500, as well as various forms of pull down shades to the sides of the support halo 500. Finally, it is possible to integrate small speakers into the sides of the support halo 500, and also possible to incorporate wiring to allow a person to input sound through a microphone jack.

In use, an occupant O will sit in, or in the case of an infant or small child, be place in the seat 100, 200 or 300. The occupant will be strapped in, as appropriate for the seat. Infants and small children in a child protective car seat 200 will be strapped in with the appropriate lap belts 223 & 224 and shoulder straps 221 & 222. Occupants of a car seat 100 and booster seat 300 will similarly be properly strapped in. The support halo 500 or 500A will then be positioned in the proper orientation on the head H of the occupant O, as described in FIGS. 9, 10 & 11. Then, in the event of an accident, the head H will move slightly due to the forces of the accident, but will be prevented from rapid or excessive movement by the support halo 500.

In a crash, or other rapid movement of the seat, the occupant O will be retrained in the seat 100, 200 or 300, but the head H will still move. In many standard car seats the seat belt locks up in a wreck, which holds the body in place. There is some slight movement, but the body remains essentially in place. The head continues to move. In most cases it moves away from the body, which includes a slight upward movement on the neck. With the support halo 500 in place, the head H will move only an inch or so, and then be stopped by the padding of the support halo. It is recognized that even this small movement can still result in some minor injuries, particularly impact injuries from the head H contacting the support halo 500 in a violent manner. The multiple layers of padding 660 & 670 of the support halo 500 should reduce some of the energy of that impact, and the fact that the skeleton 600 of the support halo 500 is made, in the most preferred embodiment of spring steel, will also reduce some of the jarring impact of the head against the support halo 500. It is recognized that there is no way that the support halo 500 can completely eliminate all possible injuries, but the use of the support halo 500 will prevent the violent and extreme movement of the head H and will significantly reduce neck and head injuries.

An additional feature of the support halo 500 is that it will protect the occupant's head H and face F from the movement of an air bag inside the vehicle. It will also provide some protection from debris and other flying objects inside the vehicle during an accident. This is particularly true when the crown protector 701 or 702 is in use with the support halo 500.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only by the spirit and scope of the claims, giving full cognizance to equivalents in all respects.

I claim:

1. A device for minimizing head and neck injury to an occupant of a vehicle, said device comprising:
a seat disposed in said vehicle;
an encircling head restraint; and
means for adjustably mounting said encircling head restraint to said seat, such that it is adjustable to position around the head of the occupant.

2. The device for minimizing head and neck injury of claim 1 wherein said encircling head restrain comprises a multisided body that defines a central opening sized to be disposed about the head of the occupant of the seat such that said encircling head restraint prevents excess movement of the head in all directions.

3. The device for minimizing head and neck injury of claim 2 wherein said central opening is sized such that allows free movement of the head of the occupant.

4. The device for minimizing head and neck injury of claim 3 wherein said seat further comprises restraining mechanism such that the occupant of the seat is restrained in said seat, and wherein said means for adjustably mounting said encircling head restrain allows said head restraint to be adjusted such that it is properly positioned on the head of the occupant, whereby, in the event of rapid movement of the vehicle the occupant is restrained within said seat, and excess movement of the occupants head is prevented by said encircling head restraint.

5. The device for minimizing head and neck injury of claim 1 further comprising;
a hinge with an internal lock mounted between said means for adjustably mounting and said encircling head restraint, wherein said encircling head restraint can be moved and locked into an up position to allow access to said seat by said occupant and a down position around said head of said occupant.

6. The device for minimizing head and neck injury of claim 1 wherein said means for adjustably mounting said encircling head restrain;
at least one adjustable and lockable mount integrated in a back portion of said seat,
at least one guide attached to said encircling head restraint,
wherein said at least one guide movably attaches to said at least one adjustable and lockable mount such that said encircling head restraint can be moved up and down and be locked into position.

7. The device for minimizing head and neck injury of claim 1 wherein said means for adjustably mounting said encircling head restrain;
a back portion of said seat wherein said back portion has a top portion;
two mounting bracket incorporated into said top portion of said seat, said two mounting brackets having a central bore therein and a locking mechanism;
two mounting posts fixedly attached to said encircling head restraint and sized to fit within said central bore, said two mounting posts further having notches to engage said locking mechanism, wherein said mounting posts are slidably engaged within said central bore and such that said mounting posts can be adjustable, and wherein said locking mechanism can engage said notches such that said mounting posts can be locked into a desired position.

8. The device for minimizing head and neck injury of claim 1 wherein said means for adjustably mounting said encircling head restrain;
a back portion of said seat;
two guide rails attached to said back portion;
two mounting collars attached to said encircling head restraint, said two mounting collars having a central bore therein, said two guide rails sized to slidably fit into said central bore;
wherein at least one of said two guide rails includes notches, and wherein at least one of said at least two mounting collars has a locking mechanism that engages said notches; and wherein said two collars can be moved up and down on said two guide rails such that said encircling head restraint is moved up and down on said guide rails, and wherein further said locking mechanism can engage said notches to lock said encircling head restraint into a desired position.

9. The device for minimizing head and neck injury of claim 1 wherein said means for adjustably mounting said encircling head a back portion of said seat;
two channels incorporated into said back portion, said channels having evenly spaced notches therein;
two sliders attached to said encircling head restrain and slidably engaged into said two channels, said sliders having pins to engage said notches;
wherein said encircling head restrain can be positioned up and down on said two channels and wherein said pins can lock said sliders into place thereby locking said encircling head restrain into a desired position.

10. The device for minimizing head and neck injury of claim 1 wherein said seat is a child protective car seat and wherein said child protective car seat is securely attached within said vehicle.

11. The device for minimizing head and neck injury of claim 1 wherein said seat is a booster seat and wherein said booster seat is securely attached within said vehicle.

12. The device for minimizing head and neck injury of claim 1 wherein said vehicle is for civilian use.

13. The device for minimizing head and neck injury of claim 12 wherein said vehicle is an automobile, a bus, a boat, an airplane or a train.

14. The device for minimizing head and neck injury of claim 1 wherein said vehicle is for military use.

15. The device for minimizing head and neck injury of claim 14 wherein said military vehicle is a tank or armored personnel carrier.

16. The device for minimizing head and neck injury of claim 2 wherein said multisided body is comprised of at least three sides, and wherein each of at least three sides has an adjustable internal skeleton, and wherein the size of the central opening can be changed by adjusting the internal skeleton such that the encircling head restrain can be sized to accommodate different sized heads.

17. The device for minimizing head and neck injury of claim 16 wherein said multisided body includes padding such that there is padding around said central opening, said padding positioned to accommodate and protect the head of the occupant.

18. The device for minimizing head and neck injury of claim 2 wherein said central opening is fixed, and wherein a multiplicity of adjustment pads can be added such that the central opening can be sized to accommodate varying sized heads of occupants.

19. The device for minimizing head and neck injury of claim 4 wherein said mounting posts are curved to position said encircling head restrain along said back portion of said seat.

20. The device for minimizing head and neck injury of claim 2 further comprising;
a crown protector disposed over said central opening of said encircling head restraint,
wherein said crown protector protects the top of the head from flying debris in the event of a wreck of said vehicle.
